(19) United States
(12) Patent Application Publication
(10) Pub. No.: US 2023/0121494 A1
(43) Pub. Date: Apr. 20, 2023

(54) ELECTRODE ASSEMBLY FOR BATTERY AND BATTERY

(71) Applicant: XIAMEN HITHIUM ENERGY STORAGE TECHNOLOGY CO., LTD., Xiamen (CN)

(72) Inventors: Yang TANG, Xiamen (CN); Nan ZHANG, Xiamen (CN); Weidong XU, Xiamen (CN); Ziqi YI, Xiamen (CN); Zuyu WU, Xiamen (CN)

(73) Assignee: XIAMEN HITHIUM ENERGY STORAGE TECHNOLOGY CO., LTD., Xiamen (CN)

(21) Appl. No.: 17/965,038

(22) Filed: Oct. 13, 2022

(30) Foreign Application Priority Data
Oct. 19, 2021 (CN) 202122519869.5

(51) Int. Cl. H01M 50/538; H01M 10/04; H01M 50/533; H01M 50/536

(52) U.S. Cl. CPC H01M 50/538; H01M 10/0431; H01M 50/533; H01M 50/536

(57) ABSTRACT

An electrode assembly for a battery and a battery are provided. The assembly has a winding main body. the winding main body has a side end face. Multiple tabs are extendedly provided on the side end face. The tabs are stacked to form a tab group. Each tab has a first side edge, a second side edge, a third side edge and a fourth side edge connected in sequence. The first side edge is opposite to the third side edge. The second side edge is opposite to the fourth side edge. The fourth side edge is fixedly connected with the side end face. The first side edge of at least one tab in the tab group is staggered in a first direction with respect to the first side edge of the topmost tab of the tab group.

### FIELD

The present application relates to the field of battery technology, and in particular, to an electrode assembly for a battery and a battery.

### BACKGROUND

The battery comprises a casing which has an opening at one end and is hollow inside, a winding main body located in the casing, and a top cover covering the opening. The winding main body is formed by sequentially winding the negative pole piece, the separator and the positive pole piece. A plurality of stacked negative pole tabs extend from one side of the negative pole piece, and the negative pole tabs of a plurality of layers form a negative pole tab group, a plurality of stacked positive tabs extend from one side of the positive pole piece, the positive pole tabs of a plurality of layers form a positive pole tab group, the positive pole adapter plate of the battery is arranged on the upper surface of the positive pole tab group and is welded and fixed with the positive pole tab group, and the negative pole adapter plate of the battery is arranged on the upper surface of the negative pole tab group and is welded and fixed with the negative pole tab group.

At present, two or more winding core bodies constitutes the battery. When there are two winding core bodies, the tab groups of the two winding core bodies need to be connected by adapter plates (the positive adapter plate is respectively connected to the positive pole tab groups of the two winding core bodies, and the negative pole adapter plate is respectively connected to the negative pole tab groups of the two winding core bodies). Usually, the adapters and the tab groups are fixed by means of ultrasonic welding.

Since a plurality of tabs in the tab group are staggered with each other, the overlapping areas of the plurality of tabs are significantly small, so that the overcurrent area on the tab group is small, thereby affecting the energy efficiency of the battery, and at the same time, affecting the welding quality between the tab group and the adapter plate.

### SUMMARY

In view of the above deficiencies, the present application provides an electrode assembly for a battery and a battery, which can not only ensure the welding quality between the tab group and the adapter plate, but also ensure the energy efficiency of the battery.

In order to solve at least the above technical problems, in the first aspect, the present application provides an electrode assembly for a battery. The electrode assembly includes a winding main body, which has a side end face on one side thereof. A plurality of tabs are extendedly provided on the side end face. The plurality of the tabs are stacked to form a tab group. Each tab includes a first side edge, a second side edge, a third side edge and a fourth side edge connected in sequence. The first side edge is opposite to the third side edge, the second side edge is opposite to the fourth side edge, and the fourth side edge is fixedly connected with the side end face. The first side edge of at least one tab in the tab group is staggered in a first direction with respect to the first side edge of the topmost tab of the tab group, and the first direction is parallel to an extending direction of the second side edge.

The tab group has a solder printing area, and the solder printing area is an area where the tab group is solder-printed and covered when the tab group is configured for welding with an adapter plate.

In a direction perpendicular to a surface of the tabs, a plurality of tabs in the tab group have an overlapping area, and the solder printing area is located in the overlapping area.

In the present application, the first side edge of at least one tab in the tab group is staggered in the first direction with respect to the first side edge of the topmost tab of the tab group. Compared with the arrangement, in which the first side edges of the plurality of tabs in the tab group are aligned, the present application reduces the technological difficulty of forming the winding main body. In addition, since the solder printing area is located in the overlapping area, the overlapping area of the plurality of tabs in the tab group is larger than the solder printing area of the tab group, which ensures the overcurrent area of the tab group and improves the energy efficiency of the battery. In addition, when the adapter plate is welded onto the tab group, the adapter plate can be welded in the overlapping areas of a plurality of tabs, which ensures the welding quality of the adapter plate.

In an embodiment, the tab group has an area ratio of an effective welding area to the overlapping area, which is smaller than or equal to 0.5.

The smaller the area ratio of the effective welding area to the overlapping area of the tab group, the larger the area of the overlapping area of the plurality of tabs in the tab group. That is to say, the distance by which the first side edges of plurality of tabs are staggered relatively to the first side edge of the topmost tab is relatively small, thereby effectively ensuring the welding quality of the tab group and the adapter plate, as well as the overcurrent area on the tab group.

In an embodiment, a spacing between the first side edge and the third side edge of each of the tabs forming the tab group is equal to that of other tabs of the tab group, and a spacing between the second side edge and the fourth side edge of each of the tabs forming the tab group is equal to that of other tabs of the tab group.

In this way, since the sizes and shapes of the plurality of tabs forming the tab group are all the same, on one hand, when the current collector is die-cut to form the tabs, the convenience of die-cutting the tabs is improved, and at the same time, it is not needed to adjust parameters of the die-cutting equipment for multiple times, which reduces the processing cost of the tabs, and on the other hand, when the tab group is formed, the staggered range of the first side edges of the plurality of tabs along the first direction is small, which increases the overlapping area of the plurality of tabs in the tab group and further improves the welding area of the tab group and the adapter plate, which ensures the energy efficiency of the battery.

In an embodiment, the first side edge of at least one tab in the tab group is coincident with the first side edge of the tab which is the topmost of the tab group.

Therefore, when the first side edges of some of the tabs in the tab group are coincident with the first side edge of the topmost tab, the overlapping area of the plurality of tabs in the tab group is effectively increased. That is to say, the ratio of the effective welding area of the tab group to the area of the overlapping area is reduced, and the welding quality of the tab group and the adapter plate can be guaranteed.

In an embodiment, the first side edges of two adjacent tabs in the tab group are staggered along the first direction.

Therefore, when the current collector is die-cut to form the tabs, the error of the spacing between two adjacent tabs is relatively large, which improves the die-cutting yield of the current collector.

In an embodiment, the first side edges of the plurality of tabs are sequentially staggered along the first direction.

Therefore, when the current collector is die-cut to form the tabs, it is possible to make the spacing between every two adjacent tabs formed by die-cutting equal, and it is not needed to complicate the parameters of the die-cutting equipment, thereby reducing the processing technology of the equipment.

In an embodiment, the first side edges of plural tabs on even-numbered layers in the tab group are sequentially staggered along the first direction, the third side edges of plural tabs on odd-numbered layers in the tab group are sequentially staggered along a second direction, and the first direction and the second direction are opposite to each other.

In this way, the first side edges of the plurality of tabs of the even-numbered layers are sequentially staggered along the first direction, and the third side edges of the plurality of tabs of the odd-numbered layers are sequentially staggered along the second direction, so that the distance by which the first side edge of the bottommost tab of the tab group is staggered relative to the first side edge of the topmost tab along the first direction can be reduced, which further ensures the overlapping area of the plurality of tabs in the tab group.

In an embodiment, a center line parallel respectively to the second side edge and the fourth side edge is between the second side edge and the fourth side edge, a distance between a first intersection point of the center line and the second side edge and a second intersection point of the center line and the fourth side edge is S, a distance between the first side edge of the tab staggered along the first direction and the first side edge of the topmost tab of the tab group is smaller than 1/19S, and a distance between the third side edge of the tab staggered along the second direction and the third side edge of the topmost tab of the tab group is smaller than 1/19S.

Therefore, when the distance between the first side edge of the tab staggered in the first direction and the first side edge of the topmost tab of the tab group is smaller and the distance between the third side edge of the tab staggered in the second direction and the third side edge of the topmost tab of the tab group is smaller, the overlapping area of the plurality of tabs in the tab group is larger. Thus, the welding quality between the tab group and the adapter plate is improved, the overcurrent area of the tab group is enlarged, and the energy efficiency of the battery is enhanced.

In a second aspect, the present application provides a battery. The battery includes an adaptor plate and the electrode assembly for a battery according to the first aspect. The adaptor plate is welded and fixed on a solder printing area of the tab group.

Since adopting the electrode assembly for a battery of the first aspect, the battery provided by the present application effectively improves the energy efficiency of the battery.

In an embodiment, when the tab group is welded to the adapter plate, the second side edges of a plurality of pole pieces in the tab group are sequentially staggered along a third direction, and the third direction is perpendicular to the first direction.

### BRIEF DESCRIPTION OF DRAWINGS

In order to illustrate the technical solutions in the embodiments of the present application more clearly, the drawings used in the embodiments will be briefly introduced below. Obviously, the drawings in the following description show only some embodiments of the present application. For those skilled in the art, other drawings can also be obtained based on these drawings without any creative efforts.

FIG. 1 is a schematic structural diagrams of an electrode assembly for a battery provided by an embodiment of the present application;

FIG. 2 is a schematic structural diagram of a pole piece provided by an embodiment of the present application;

FIG. 3 is a schematic structural diagram of a tab group and an adapter plate provided by an embodiment of the present application during welding;

FIG. 4 is a partial enlarged schematic diagram of the portion A in FIG. 3;

FIG. 5 is another structural schematic diagrams of an electrode assembly for a battery provided by an embodiment of the present application;

FIG. 6 is still another schematic structural diagrams of an electrode assembly for a battery provided by an embodiment of the present application;

FIG. 7 is yet another schematic structural diagrams of an electrode assembly for a battery provided by an embodiment of the present application;

FIG. 8 is a schematic diagram of an end face of the electrode assembly for a battery provided by an embodiment of the present application;

FIG. 9 is a schematic structural diagram of the battery provided by an embodiment of the present application; and

FIG. 10 is a schematic diagram of the electrode assembly for a battery provided by an embodiment of the present application, which is in a state of being located in the casing.

### DESCRIPTION OF REFERENCE NUMBERS

10—battery;
100—battery core; 110—winding main body; 111—side end face; 112—negative pole piece; 113—positive pole piece; 114—separator; 12a—overlapping area; 12b—solder printing area; 12c—effective welding area; 120—tab group; 120a—positive pole tab group; 120b—negative pole tab group; 121—tab; 121a—first side edge; 121b—second side edge; 121c—third side edge; 121d—fourth side edge; 121e—center line; 1211—positive pole tab; and 1212—negative pole tab;
200—top cover; 201—adapter plate;
300—casing; 310—opening; 320—accommodating cavity.

### DESCRIPTION OF EMBODIMENTS

The technical solutions in the embodiments of the present application will be clearly and completely described below with reference to the drawings in the embodiments of the present application. Obviously, the described embodiments are only a part of the embodiments of the present application, rather than all the embodiments. Based on the embodiments of the present application, all other embodiments obtained by those skilled in the art without creative work fall within the protection scope of the present application.

In the present application, the orientation or positional relationship, indicated by the terms, “upper”, “lower”, “left”, “right”, “front”, “rear”, “top”, “bottom”, “inner”, “outer”, “vertical””, “horizontal”, “crosswise”, “longitudinal”, etc., is based on the orientation or positional relationship shown in the drawings. These terms are primarily intended to better describe the present application and the embodiments thereof, and not to stipulate that the indicated device, element or component must be in the particular orientation, or be constructed and operated in the particular orientation.

In addition, some of the above-mentioned terms may be used to express other meanings besides orientation or positional relationship. For example, the term “on” may also be used to express a certain attachment or connection relationship in some cases. For those skilled in the art, the specific meanings of these terms in the present application can be understood according to specific situations.

Furthermore, the terms, “installed”, “arranged”, “provided”, “connected”, “connected with each other” should be construed broadly. For example, it may be a fixed connection, a detachable connection, or a unitary structure; it may be a mechanical connection, or an electrical connection; it may be directly connected, or indirectly connected through an intermediary, or internally communicated between two devices, elements, or components. For those skilled in the art, the specific meanings of the above terms in the present application can be understood according to specific situations.

In addition, the terms, “first”, “second”, etc., are mainly used to distinguish different devices, elements or components (the specific types and structures may be the same or different), and not to indicate or imply the importance of relativity and the number of the indicated devices, elements or components, etc. Unless stated otherwise, “plurality” means two or more.

At present, two or more winding core bodies constitute the battery. When there are two winding core bodies, the tab groups of the two winding core bodies need to be connected by adapter plate (the positive pole adapter plate is respectively connected to the positive pole tab groups of the two winding core bodies, and the negative pole adapter plate is respectively connected to the negative pole tab groups of the two winding core bodies). Usually, ultrasonic welding is used to fix the adapter plate and the tab groups.

Since the plurality of tabs in the tab group are staggered relatively to each other, the overlapping area of the plurality of tabs is significantly small, so that the overcurrent area on the tab group is small, thereby affecting the energy efficiency of the battery, and at the same time affecting the welding quality between the tab group and the adapter plate.

In view of this point, the embodiments of the present application provide an electrode assembly for a battery and a battery, which can not only ensure the welding quality between the tab group and the adapter plate, but also ensure the energy efficiency of the battery.

The electrode assembly for a battery of the battery and the battery are described in detail below through embodiments.

In order to facilitate the understanding on the electrode assembly for a battery provided by the embodiments of the present application, the structure of the electrode assembly for a battery is first described. The electrode assembly for a battery comprises an electrode unit and a tab, wherein the electrode unit comprises a positive pole piece, a separator and a negative pole piece.

In an embodiment, the negative pole piece, the separator and the positive pole piece are stacked and wound in sequence to form the electrode unit of the electrode assembly for a battery, that is, the electrode unit is of a wound structure. In another embodiment, the negative pole piece, the separator and the positive pole piece are sequentially stacked to form an electrode unit of the electrode assembly for a battery, and the electrode unit is of a laminated structure. In addition, the formed electrode unit has a gap, and the electrolyte can enter the electrode unit through the gap and infiltrate the negative pole piece and the positive pole piece.

Herein, the negative pole piece comprises a negative pole current collector (such as copper foil) and a negative pole active material layer (such as carbon or silicon) coated on the surface of the negative pole current collector, and the positive pole piece comprises a positive pole current collector (such as aluminum foil) and the positive pole active material layer (e.g., ternary material, lithium iron phosphate or lithium cobaltate) coated on the surface of the positive pole current collector. The negative pole tab is connected to the negative pole piece and protrudes from the electrode unit, and the negative pole tabs can be directly formed by cutting the negative pole current collector; and the positive pole tab is connected to the positive pole piece and protrudes from the electrode unit, and the positive pole tabs can be directly formed by cutting the positive pole current collector.

Hereinafter, a detailed description will be given by taking an electrode unit as an example of an electrode assembly for a battery of a wound structure.

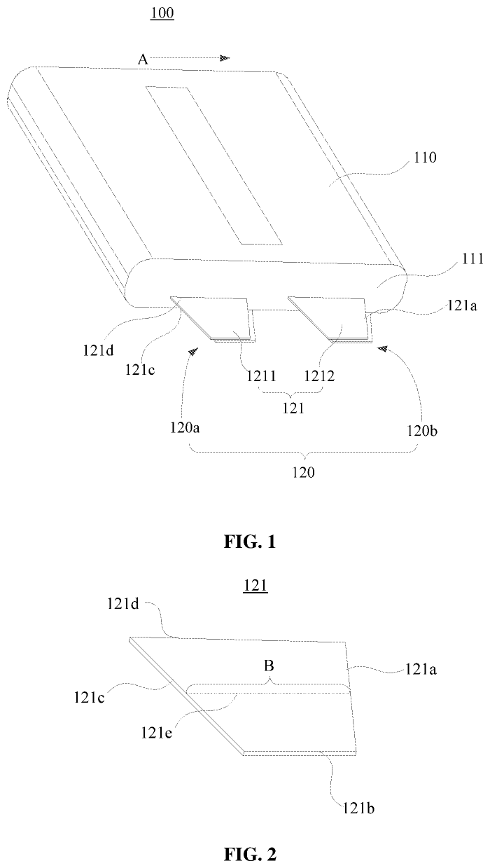

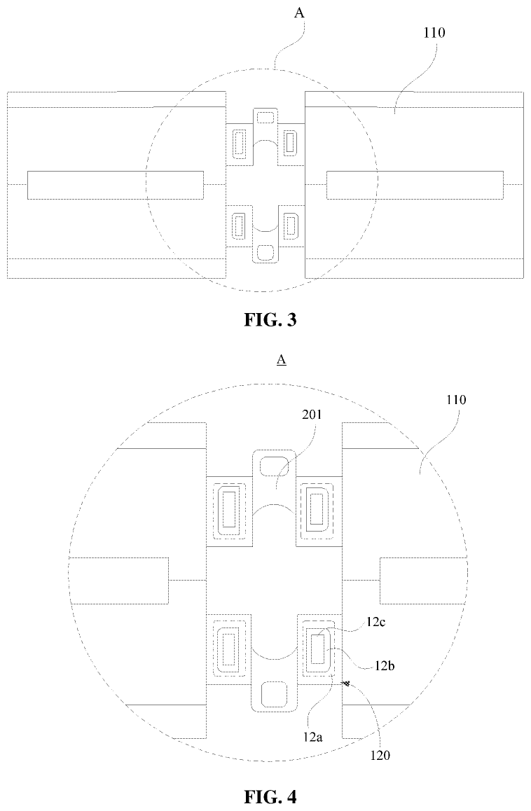

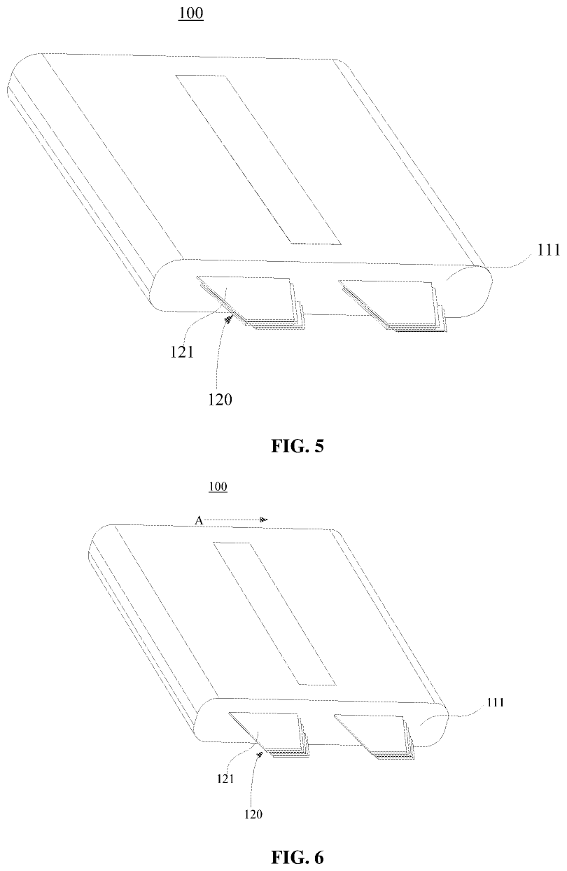

An electrode assembly for a battery is provided by an embodiment of the present application. As shown in FIGS. 1 and 2, the electrode assembly for a battery comprises a winding main body 110. On one side of the winding main body 110, a side end face 111 is provided. The side end face 111 is provided with a plurality of tabs 121 extending thereon, and the plurality of tabs 121 are stacked to form a tab group 120. Referring to FIG. 2, the tab 121 comprises a first side edge 121a and a second side edge 121b, the third side edge 121c and the fourth side edge 121d that are connected in sequence. The first side edge 121a is opposite to the third side edge 121c, the second side edge 121b is opposite to the fourth side edge 121d, and the fourth side edge 121d is fixedly connected with the side end face 111. The first side edge 121a of at least one of the tabs 121 in the tab group 120 is staggered along the first direction with respect to the first side edge 121a of the topmost tab 121 of the tab group 120, and the first direction is parallel with the extending direction of the second side edge 121b. In addition, referring to FIG. 3 and FIG. 4, the tab group 120 has a solder printing area 12b, and the solder printing area 12b is the area where the tab group 120 is soldering-printed and covered when the tab group 120 is used to welded with the adapter plate. In the direction perpendicular to the surface of the tab 121, the plurality of tabs 121 in the tab group 120 have an overlapping area 12a, and the solder printing area 12b is located in the overlapping area 12a.

The first direction mentioned below refers to the direction indicated by Arrow A in FIG. 1.

It should be noted that the planar direction of the above-mentioned side end face 111 is perpendicular to the winding direction of the winding main body 110. The side end face 111 refers to the end face of the winding main body 110 provided with the tab 121. The topmost tab 121 of the tab group 120 refers to the tab 121 close to the innermost side of the winding main body 110, that is, the tab 121 close to the center of the side end face 111.

In addition, the first side edge 121a, the second side edge 121b, the third side edge 121c and the fourth side edge 121d are connected in turn to form the surrounding edges of the tab 121. For example, if the tab 121 is trapezoidal, the second side edge 121b and the fourth side edge 121d are the upper and lower bases of the trapezoid, respectively, and the second side edge 121b and the fourth side edge 121d are the two waists of the trapezoid, respectively.

The first side edge 121a of at least one tab 121 in the tab group 120 is staggered in the first direction with respect to the first side edge 121a of the topmost tab 121 of the tab group 120. It should be understood that the plurality of tabs 121 are all staggered in the first direction with respect to the first side edge 121a of the topmost tab 121 of the tab group 120. Alternatively, some of the tabs 121 in the tab group 120 are staggered along the first direction with respect to the first side edge 121a of the topmost tab 121 of the tab group 120, and some of the tabs 121 are staggered along the second direction with respect to the third side edge 121c of the topmost tab 121 of the tab group 120. The first direction is opposite to the second direction. Or alternatively, two adjacent tabs 121 in the tab group 120 are staggered along the first direction or the second direction, and so on.

In this embodiment, by making the first side edge 121a of at least one tab 121 in the tab group 120 staggered along the first direction relative to the first side edge 121a of the topmost tab 121 of the tab group 120, the processing difficulty of forming the winding main body 110 is reduced, compared with the arrangement in which the first side edges 121a of the plurality of tabs 121 in the tab group 120 are aligned. In addition, since the solder printing area 12b is located in the overlapping area 12a, the overlapping area of the plurality of tabs 121 in the tab group 120 is larger than the solder printing area 12b of the tab group 120, which ensures the overcurrent area of the tab group 120 and increases the energy efficiency of the battery. In addition, when the adapter plate is welded on the tab group 120, the adapter plate can be welded in the overlapping area 12a of the plurality of tabs 121, which ensures the welding quality of the adapter plate.

In an alternative embodiment, the area ratio of the effective welding area 12c to the overlapping area 12a of the tab group 120 is smaller than or equal to 0.5.

The smaller the area ratio of the effective welding area 12c to the overlapping area 12a of the tab group 120, the larger the area of the overlapping area 12a of the plurality of tabs 121 in the tab group 120, that is to say, the distance by which the first side edge 121a of the plurality of tabs 121 is staggered with respect to the first side edge 121a of the topmost tab 121 is smaller, thereby effectively ensuring the welding quality of the tab group 120 and the adapter plate 201 and the overcurrent area on the tab group 120.

When the area ratio of the effective welding area 12c to the overlapping area 12a of the tab group 120 is greater than 0.5, the overlapping area of the plurality of tabs 121 in the tab group 120 is smaller, which affects the welding quality of the tab group 120 and the adapter plate 201 on the one hand, and reduces the overcurrent area on the tab group 120 on the other hand, thereby affecting the energy efficiency of the battery. Therefore, in this embodiment, the area ratio of the effective welding area 12c to the overlapping area 12a of the tab group 120 is selected as being smaller than or equal to 0.5, which is suitable.

It should be noted that the effective welding area 12c of the tab group 120 refers to the area where the tab group 120 and the adapter plate 201 are fixedly connected when the tab group 120 is welded with the adapter plate 201.

In some embodiments, the distance between the first side edge 121a and the third side edge 121c of each tab 121 forming the tab group 120 is equal to that of other tabs thereof, and the distance between the second side edge 121b and the fourth side edge of each tab 121 forming the tab group 120 is equal to that of other tabs thereof.

The sizes and shape of the plurality of tabs 121 forming the tab group 120 are all identical. On the one hand, when the current collector is die-cut to form the tabs 121, the die-cutting convenience of the tabs 121 is improved, and at the same time, there is no need for adjusting the parameters of the die-cutting equipment for many times, which reduces the processing cost of the tabs 121. On the other hand, when forming the tab group 120, the staggered range of the first side edges 121a of the plurality of tabs 121 along the first direction is relatively small, the overlapping area of the plurality of tabs 121 in the tab group 120 is increased, and the welding area of the tab group 120 and the adapter plate 201 is further improved, thereby ensuring the energy efficiency of the battery.

In an alternative embodiment, as shown in FIG. 5, the first side edge 121a of at least one tab 121 in the tab group 120 is coincide with the first side edge 121a of the topmost tab 121 of the tab group 120.

That is to say, the first side edges 121a of a part of the tabs 121 in the tab group 120 are coincident with the first side edge 121a of the topmost tab 121, and the first side edges 121a of another part of the tabs 121 in the tab group 120 are staggered along the first direction with respect to the first side edge 121a of the topmost tab 121. Since the plural tabs 121 in the tab group 120 are identical in size and shape, when the first side edge 121a of part of tabs 121 in the tab group 120 is coincide with the first side edge 121a of the topmost tab 121, the tabs 121 of this part completely coincide with the topmost tab 121, and the corresponding coinciding area is the surface area of the tab 121. When the first side edges 121a of the tabs of another part of the tab group 120 are staggered along the first direction with respect to the first side edge 121 of the topmost tab 121, the third side edges 121c of the tabs of the another part are staggered along the first direction with respect to the third side edge 121c of the topmost tab 121. That is, when the first side edges 121a of the tab 121 of the another part protrude from the first side edge 121a of the topmost tab 121 along the first direction, the third side edges 121c of the tabs 121 of the another part extend into the third side edge 121c of the topmost tab 121 along the first direction.

Therefore, when the first side edges 121a of some of the tabs 121 in the tab group 120 are coincident with the first side edge 121a of the topmost tab 121, it effectively increases the overlapping area of the plural tabs 121 in the tab group 120, that is, the ratio of the effective welding area 12c to the overlapping area 12a of the tab group 120 is reduced, which ensures the welding quality of the tab group 120 and the adapter plate 201.

In another embodiment, as shown in FIG. 1, the first side edges 121a of two adjacent tabs 121 in the tab group 120 are staggered along the first direction.

Therefore, when the current collector is die-cut to form the tabs 121, the error of the spacing between two adjacent tabs 121 is relatively large, and the yield of die-cutting of the current collector is improved.

In another embodiment, as shown in FIG. 6, the first side edges 121a of the plurality of tabs 121 are sequentially staggered along the first direction.

Therefore, when the current collector is die-cut to form the tabs 121, the distance between the two adjacent tabs 121 formed by die-cutting can be made equal, and it is not needed to complicate the parameters of the die-cutting equipment, thereby reducing difficulty of processing technology of the die-cutting equipment.

Optionally, the staggered distance of the first side edges 121a of every two adjacent tabs 121 in the plurality of tabs 121, along the first direction, is the same.

When the tabs 121 are formed by die-cutting, it is only necessary to set the die-cutting parameters of the die-cutting equipment, so that after the pole piece is wound, in the tabs 121 by die-cutting, the staggered distance of the first side edges 121a of every two adjacent tabs 121, along the first direction, is the same. Therefore, it is easy to obtain the total staggered distance of the first side edges 121a of the plurality of tabs 121 along the first direction, thereby facilitating the calculation of the effective welding area 12c of the tab group 120.

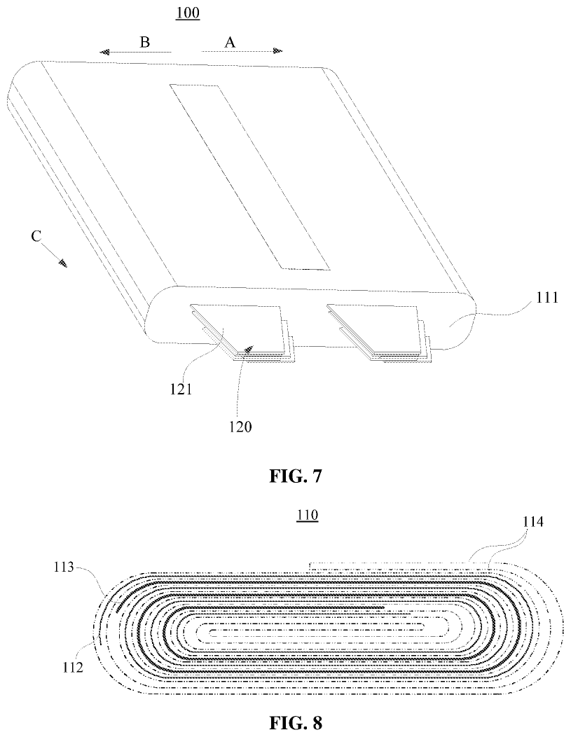

In another embodiment, as shown in FIG. 7, the first side edges 121a of the plurality of tabs 121 in the even-numbered layers in the tab group 120 are sequentially staggered along the first direction, and the third side edges 121c of the plurality of tabs 121 in the even-numbered layers in the tab group 120 are sequentially staggered along the second direction, and the first direction and the second direction are opposite to each other.

It should be noted that the above even-numbered layers are defined by counting from the upper surface of the tab group 120 to the lower surface thereof, or from the lower surface of the tab group 120 to the upper surface thereof, such as, the second layer, the fourth layer, the sixth layer and so on. The above-mentioned odd-numbered layers are defined by counting from the upper surface of the tab group 120 to the lower surface thereof, or from the lower surface of the tab group 120 to the upper surface thereof, for example, the first layer, the third layer, the fifth layer, and so on.

It should also be noted that the above-mentioned second direction refers to the direction parallel to the extending direction of the second side edge 121b and opposite to the direction of the first direction, that is, the direction indicated by Arrow B in FIG. 7.

In this embodiment, the first side edges 121a of the plurality of tabs 121 in the even-numbered layers are sequentially staggered along the first direction, and the third side edges 121c of the plurality of tabs 121 in the odd-numbered layers are sequentially staggered along the second direction, so that the distance, by which the first side edge 121a of the bottommost tab 121 in the tab group 120 is staggered relative to the first side edge 121a of the topmost tab 121 along the first direction, can be reduced, further ensuring that the overlapping area 12a of the plural tabs 121 in the tab group 120.

Optionally, the staggered distances of the first side edges 121a of the plurality of tabs 121 in the even-numbered layers in the tab group 120 along the first direction are the same, and the staggered distances of the third side edges 121c of the plurality of tabs 121 in the odd-numbered layers in the tab group 120 along the second direction are the same. In this way, the total staggered distance of the plurality of tabs 121 in the tab group 120 can be easily obtained, and thus the area of the overlapping area 12a of the plurality of tabs 121 in the tab group 120 can be easily obtained.

Only several structures, in each of which the plurality of tabs 121 in the tab group 120 are staggered, are enumerated in the above. The present application is not limited to this, but may have more structure, which will not be listed one by one here.

In some embodiments, a center line 121e parallel to the second side edge 121b and the fourth side edge respectively is provided between the second side edge 121b and the fourth side edge, and the distance between a first intersection point of the center line 121e and the second side edge 121b and the second intersection point of the center line 121e and the fourth side edge is S. The distance between the first side edge 121a of the tab 121 staggered in the first direction and the first side edge of the topmost tab 121 of the tab group 120 is smaller than or equal to 1/19S, and the distance between the third side edge 121c of the tab 121 staggered in the second direction and the third side edge 121c of the topmost tab 121 of the tab group 120 is smaller than or equal to 1/19S.

For example, if the distance S between the first intersection point and the second intersection point is between 73 mm and 81 mm, then the distance between the first side edge 121a of the tab 121 staggered in the first direction and the first side edges 121a of the topmost tab 121 in the tab group 120 is smaller than 3.8 mm-4.3 mm, and the distance between the third side edge 121c of the tab 121 staggered along the second direction and the third side edge 121c of the topmost tab 121 in the tab group 120 is smaller than 3.8 mm-4.3 mm Thus, the overlapping area of the plurality of tabs 121 in the tab group 120 is ensured by defining the staggered distance from the first side edge 121a of the topmost tab 121 of the tab group 120 along the first direction and the staggered distance from the third side edge 121c of the topmost tab 121 of the tab group 120 along the second direction.

In this embodiment, the smaller the distance between the first side edge 121a of the tab 121 staggered in the first direction and the first side edge 121a of the topmost tab 121 of the tab group 120 and the distance between the third side edge 121c of the tab 121 staggered in the second direction and the third side edge 121c of the topmost tab 121 of the tab group 120, the larger the overlapping area of the plurality of tabs 121 in the tab group 120, the better the welding quality between the tab group 120 and the adapter plate 201, the larger the overcurrent area of the tab group 120, and the higher the energy efficiency of the battery.

When the distance between the first side edge 121a of the tab 121 staggered in the first direction and the first side edge 121a of the topmost tab 121 of the tab group 120 is greater than 1/19S and the distance between the third side edge 121c of the tab 121 staggered in the second direction and the third side edge 121c of the topmost tab 121 of the tab group 120 is greater than 1/19S, the area of the overlapping area 12a of the tab group 120 is relatively small, so that the overcurrent area of the tab group 120 is relatively small, thereby affecting the energy efficiency of the battery.

In some embodiments, as shown in FIGS. 1 and 8, the winding main body 110 comprises a negative pole piece 112, a separator 114 and a positive pole piece 113, and the separator 114 is arranged between the adjacent negative pole piece 112 and the positive pole piece 113 and spaced apart from them. The tab group 120 comprises a negative pole tab group 120b and a positive pole tab group 120a, the tabs 121 in the negative pole tab group 120b are connected to the negative pole piece 112, and the tabs 121 in the positive pole tab group 120a are connected to the positive pole piece 113.

Here, the tabs 121 in the negative pole tab group 120b are referred to as negative pole tabs 1212, and the tabs 121 in the positive pole tab group 120a are referred to as positive pole tabs 1211.

Since the negative pole piece 112 has a plurality of negative pole tabs 1212, the plurality of negative pole tabs 1212 are distributed at predetermined intervals along the extending direction of the pole piece. Thus, when the winding main body 110 is formed, the negative pole tabs 1212 on the negative pole piece 112 can be stacked on the side end face 111, to form a negative pole tab group 120b, and the first side edges 121a of the plurality of negative pole tabs 1212 can be provided as staggered, or the first side edges 121a of the plurality of tabs 121 of the even-numbered layers of the tab group 120 can be sequentially staggered along the first direction, while the third side edges 121c of the plurality of tabs 121 of the odd-numbered layers of the tab group 120 are staggered once along the second direction. Similarly, the positive pole tabs 1211 on the positive pole piece 113 can be stacked on the side end face 111 to form a positive pole tab group 120a, and the first side edges 121a of the plurality of positive pole tabs 1211 can be provided as staggered.

In some embodiments, the tabs 121 in the positive pole tab group 120a are made of aluminum, and the tabs 121 in the negative pole tab group 120b are made of copper.

The reliability is higher when the components of the same material are welded with each other. The material of the positive pole adapter for being welded with the positive pole tab group 120a is aluminum, and the material of the negative pole adapter plate for be welded with the negative pole tab group 120b is copper. Therefore, in order to improve the reliability of welding between the positive pole tab group 120a and the positive pole adapter plate, the material of the tabs 121 in the positive pole tab group 120a is designed as aluminum. In order to improve the reliability of welding between the negative pole tab group 120b and the negative pole adapter plate, the material of the tabs 121 in the negative pole tab group 120b is designed as copper.

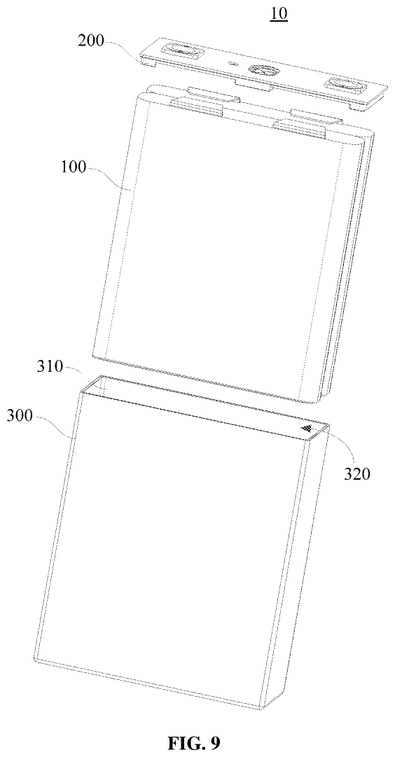

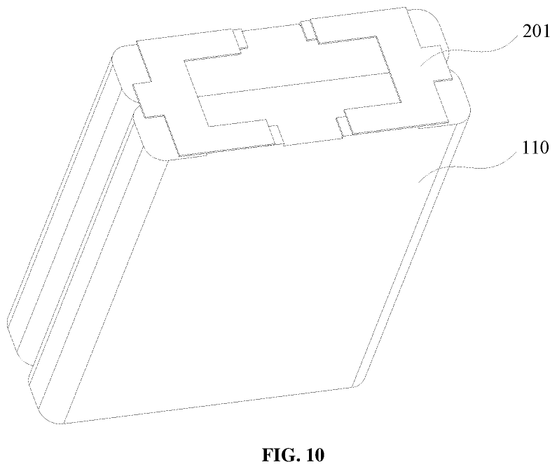

As shown in FIG. 9 and FIG. 10, the embodiment of the present application provides a battery 10. The battery 10 comprises an adapter plate 201 and the above-mentioned electrode assembly for a battery 100, wherein the adapter plate 201 is welded and fixed to the solder printing area 12b of the tab group 120.

The battery 10 in this embodiment adopts the above-mentioned electrode assembly for a battery, and the electrode assembly for a battery can improve the welding quality of the tab group 120 and ensure the overcurrent area of the tab group 120. Thus, this embodiment can improve the energy efficiency of the battery 10.

In some embodiments, the battery 10 further comprises a casing 300 for accommodating the electrode assembly for a battery and a top cover 200 covering the casing 300.

An accommodating cavity 320 is formed inside the casing 300 for accommodating the electrode assembly for a battery and electrolyte. The casing 300 is provided with an opening 310 at one end, so that the electrode assembly for a battery can be placed in the accommodating cavity 320 of the casing 300 through the opening 310. A plurality of electrode assemblies for a battery may be provided within the accommodating cavity 320, the plurality of electrode assemblies for a battery are stacked and electrically connected to each other, and the top cover 200 is sealed at the opening 310 of the casing 300 to prevent the electrolyte from leaking out.

It should be noted that, the above-mentioned casing 300 may be hexahedral or be of other shapes. The material of the casing 300 may be a metal material, such as aluminum or aluminum alloy, etc., or an insulating material, such as plastic, etc.

It should also be noted that the above-mentioned battery 10 refers to a secondary battery, which is also called a rechargeable battery or a storage cell, which means a battery 10 that can be used continuously by activating the active material by charging after the battery 10 is discharged.

Since a plurality of electrode assemblies for a battery can be provided and stacked in the accommodating cavity 320 of the casing 300, and every two adjacent electrode assemblies for a battery are electrically connected with each other, in one embodiment, as shown in FIG. 3 and FIG. 10, between every two adjacent electrode assemblies for a battery, the purpose of electrically connecting the two adjacent electrode assemblies for a battery is achieved by welding and fixing the adapter plate 201 onto the tab group 120. When the adapter plate 201 is welded to the tab group 120, the tab group 120 is squeezed along its thickness direction, so that the overlapping areas 12a of the plurality of tabs 121 are attached to each other, and therefore the tab group 120 is welded with the adapter plate 201.

When the tab group 120 is squeezed along its thickness direction to make the overlapping areas 12a of the plurality of tabs 121 attached with each other, the tab group 120 and the adapter plate are welded. At this time, the second side edges 121b of the plural tabs 121 in the tab group 120 are sequentially staggered along the third direction, and the third direction is perpendicular to the first direction.

It should be noted that the above-mentioned third direction is the direction indicated by Arrow C in FIG. 7.

Finally, it should be noted that the above embodiments are only used to illustrate the technical solutions of the present application, but not to limit it. Although the present application has been described in detail with reference to the foregoing embodiments, those skilled in the art should understand that it is still possible to modify the technical solutions recorded in the foregoing embodiments, or perform equivalent replacements to some or all of the technical features. These modifications or replacements do not make the essence of the corresponding technical solutions deviate from the scopes of technical solutions of various embodiments of the present application.

What is claimed is:

1. An electrode assembly for a battery, the electrode assembly comprising:
a winding main body, wherein the winding main body has a side end face; and
a plurality of tabs provided on the side end face and extending from the side end surface,
wherein:
the plurality of the tabs are stacked to form a tab group,
each of the plurality of tabs comprises a first side edge, a second side edge, a third side edge and a fourth side edge connected in sequence, the first side edge is opposite to the third side edge, the second side edge is opposite to the fourth side edge, the fourth side edge is fixedly connected with the side end face, the first side edge of the outermost tab of the plurality of tabs and the first side edge of at least one tab in the remaining tabs are staggered in a first direction, and the first direction is parallel to an extending direction of the second side edge; and
in a direction perpendicular to surfaces of the tabs, the plurality of tabs in the tab group have an overlapping area.

2. The electrode assembly for a battery according to claim 1, wherein:
gaps between the first side edges and the third side edges of the plurality of tabs are identical, and
gaps between the second side edges and the fourth side edges of the plurality of tabs are identical.

3. The electrode assembly for a battery according to claim 2, wherein the first side edge of the outermost tab of the plurality of tabs overlaps the first side edge of at least one tab in the remaining tabs.

4. The electrode assembly for a battery according to claim 2, wherein the first side edges of two adjacent tabs in the tab group are staggered along the first direction.

5. The electrode assembly for a battery according to claim 4, wherein the first side edges of the plurality of tabs are sequentially staggered along the first direction.

6. The electrode assembly for a battery according to claim 2, wherein:
the first side edges of the tabs on even-numbered layers in the tab group are sequentially staggered along the first direction,
the third side edges of the tabs on odd-numbered layers in the tab group are sequentially staggered along a second direction, and
the first direction and the second direction are opposite to each other.

7. The electrode assembly for a battery according to claim 6, wherein:
a center line parallel to the second side edge and the fourth side edge is between the second side edge and the fourth side edge,
a distance between a first intersection point of the center line and the first side edge and a second intersection point of the center line and the third side edge is S,
a distance between the first side edge of the tab staggered along the first direction and the first side edge of the outermost tab of the tab group is smaller than 1/19S, and
a distance between the third side edge of the tab staggered along the second direction and the third side edge of the outermost tab of the tab group is smaller than 1/19S.

8. A battery comprising:
the electrode assembly according to claim 1, the tab group having a weld mark area located in the overlapping area; and
a connection plate, welded and fixed to the weld mark area of the tab group.

9. The electrode assembly according to claim 8, wherein an area ratio of an effective welding area in the weld mark area to the overlapping area is smaller than or equal to 0.5.

10. The battery according to claim 8, wherein when the tab group is welded to the connection plate, the second side edges of the plurality of tabs are sequentially staggered along a third direction, and the third direction is perpendicular to the first direction.
